(19) United States
(12) Patent Application Publication
(10) Pub. No.: US 2013/0154503 A1
(43) Pub. Date: Jun. 20, 2013

(54) METHOD TO CONTROL A LIGHTING CURRENT OF A LIGHTING DEVICE

(71) Applicant: Nikolaus Decius, Lippstadt (DE)

(72) Inventor: Nikolaus Decius, Lippstadt (DE)

(73) Assignee: Hella KgaA, Lippstadt (DE)

(21) Appl. No.: 13/641,646

(22) PCT Filed: Apr. 11, 2011
(86) PCT No.: PCT/EP2011/055607

§ 371 Date: Jan. 2, 2013

(30) Foreign Application Priority Data
Apr. 16, 2010 (DE) 1020100015125.4

(51) Int. Cl. H05B 37/02

(52) U.S. Cl. CPC H05B 37/02
USPC 315/250

(57) ABSTRACT

A method for controlling a lighting current of a lighting device with a number of semiconductor lighting means, installed for signaling and marking traffic areas of airports, in which period intervals are predetermined with a fixed period length, selected with an average lighting current to operate a semiconductor lighting means within the period intervals and in each of the period intervals a number of current pulses is generated with a pulse amplitude I_{P} and a fixed pulse duration T, with the number of current pulses in each period interval being selected such that within the period intervals the respectively predetermined average lighting current is reached, with the pulse pauses being variably adjusted between subsequent current pulses.

The present invention relates to a method for controlling a lighting current of a lighting device with a number of semiconductor lighting means, implemented for signaling and marking traffic areas of airports, in which

period intervals with a fixed period length are predetermined, an average lighting current is selected to operate the semiconductor lighting means within the period intervals, and in each period interval a number of power impulses is generated with a pulse amplitude I_{P} and a fixed pulse duration T.

Lighting devices of the above-stated type suitable to signal and mark traffic areas in airports and to emit signals are known from prior art in various embodiments. For example, the starting and landing runways and tarmacs of airports are provided with respective lighting devices, which can signal, for example, the start, end, and center of a runway as well as furthermore individual sections of the tarmac. In such lighting devices, particularly embodied as sub-surface lighting devices, frequently halogen lighting means are used that show a typical life of approximately 1000 to 1500 operating hours and thus must be replaced relatively frequently. Another disadvantage of halogen lighting means comprises that during operation they consume a relatively large amount electric energy.

It is known from prior art in lighting devices used for signaling and marking traffic areas of airports to replace halogen lighting means with lighting means on a semiconductor basis, particularly light diodes. EP 0 898 683 B1 as well as EP 0 898 684 B1 disclose such lighting devices for example. Additional lighting devices for signaling and marking traffic areas of airports, in which semiconductor elements are used as light sources, are known from WO 2009/077010 A1, WO 97/44614 A1, or WO 97/44612 A1.

In order to allow varying the electric power and thus the intensity of the light emitted by the semiconductor lighting means a respective control device is provided at the lighting device. According to prior art either the power supply for the semiconductor lighting means is respectively adjusted to the desired lighting current. In an alternative method the power supply is set fixed for a maximum illumination in a predetermined period interval, with the current being continuously switched on and off with high frequency via a pulse width modulated signal (PWM signal). Here, the ratio between the length of the switch-on pulse to the duration of the period interval can be controlled between 0% (“off”) and 100% (“on”) and this way the intensity of the lighting current can be determined within the period interval and thus also the brightness of the semiconductor lighting means of the lighting device. Here, the control device generates signals with a fixed period length, with the pulse duration within a period determining the switch-on duration of a lighting means within the period interval. Here, the pulse duration must be determined for the desired brightness, which states the relative switch-on duration in reference to the period length of the signal. As an example, EP 0 898 684 B1 describes a lighting device suitable for signaling and marking traffic areas of airports and comprising light diodes, which can be controlled and dimmed with the help of such a pulse width modulation method.

In a pulse width modulation method known from prior art for controlling the brightness of a semiconductor lighting means a high basic frequency is required, so that the light emitted is experienced by the human eye as constant and pleasant. Otherwise, a so-called “bead-line effect” develops. In this context the relatively high technical expense for generating the pulse width modulation signals is disadvantageous, on the one hand, which is preferably realized via a control device showing a conventional microcontroller. Additional disadvantages are the visible brightness variations in the form of a flickering of the semiconductor lighting means at very low control powers, namely at very short switch-on pulses with the nominal current I_{NENN} and a very long pulse pause, as well as high switching frequencies, which for optical reasons are required for the lighting means, however generating loss in power in the switching elements and causing electromagnetic interference radiation.

In general it applies that a semiconductor lighting means can only assume two states when digitally addressed and controlled, namely the status “on” when the nominal current I_{NENN} flows and the status “off” when the current is switched off. At high switching frequencies exceeding 100 Hz the human eye cannot detect the switch-on pulses any longer and experiences the arithmetic average of the light signal as a steady lighting current.

In order to influence the arithmetic average of a digital signal the scanning level of the nominal current I_{NENN}

$$a = \frac{{t}_{e}}{{t}_{e} + {t}_{a}} = \frac{{t}_{e}}{T}$$

with tₑ=period switched on, tₐ=period switched off, and T=duration of period must be adjusted. The above-described pulse width modulation (PWM) operates here with variable switch-on periods and fixed period durations.

In literature another modulation method is also described in order to control direct current transformers, which is called pulse sequence modulation or pulse frequency modulation. The pulse sequence modulation is also suitable for a digital control of semiconductor lighting means. In this method, contrary to pulse width modulation, a pause period is modulated and the switch-on time is kept constant. This method can be implemented by very simple technology, by a controlled oscillator triggering a mono flop, which here emits a fixed set switch-on pulse as the signal current.

The present invention is based on the objective to provide an alternative method for controlling a lighting current of a lighting device of the type mentioned at the outset, which can be implemented with simple and cost-effective technology and can efficiently address the semiconductor lighting means.

This objective is attained in a method of the type mentioned at the outset showing the features of the characterizing part of claim 1. Advantageous further embodiments of the invention are disclosed in the dependent claims.

The method according to the invention is characterized such that the number of current pulses in each period interval is selected such that within the period intervals the respectively predetermined average lighting current is achieved, with the pulse pauses being adjusted variably between subsequent current pulses. The control method presented here for the semiconductor lighting means of the lighting device is based on a modulated controlled current, however it uses a different modulation method. The control method according to the invention provides that, depending on the desired average lighting current within a period interval with a fixed period length, the number of switch-on pulses, all showing a constant pulse duration, are determined for each period interval. The length of the period interval is predetermined here and thus not variable. This way, the number of pulses is modulated in a certain period interval. Contrary to the pulse sequence modulation known from prior art a discrete number of current pulses is generated per (fixed) period interval, while the pulse sequence modulation linearly modulates the pulse duration of the period interval. In the method according to the invention here the case can occur that less than an integer multiple of the pulse and the pause fit into the period interval, so that for example the last pause within a period interval can be shorter or longer than the previous pauses within said period interval. The pulse pauses between subsequent current pulses can be variably adjusted in the method according to the invention so that at least the pulse pauses between some current pulses may be different. The advantage of the method presented here is the simple technical realization by a pulse generator, particularly a mono flop suitable for generating a current pulse being triggered by a counter within a fixed period interval so frequently that the average lighting current is achieved in an advantageous embodiment, for example. At the end of the period interval the counter is reset and restarted for the next period interval.

In another particularly advantageous embodiment it is suggested that the pulse amplitudes I_{P} of at least some current pulses are adjusted to the nominal current I_{NENN} of the semiconductor lighting means. It may also be provided that the pulse amplitudes I_{P} of all current pulses are adjusted to the nominal current I_{NENN} of the semiconductor lighting means. Alternatively there is also the option to adjust the pulse amplitudes I_{P} of at least some current pulses such that they are smaller than the nominal current I_{NENN} of the semiconductor lighting means. The number of current pulses is selected in each period interval such that within the period interval the respectively predetermined average current is reached. The pulse pauses between subsequent current pulses are here adjusted variably.

Here it is particularly advantageous that the period duration in the method presented here may be greater than during the pulse width modulation, namely with identical or even better optic appearance of the lighting device. In low or moderate lighting current, due to the increasing number of switch-on pulses, automatically the effective frequency increases, thus leading to a lighting current experienced more homogeneously. This effect is particularly advantageous because the operating conditions occur particularly frequently. In large lighting currents the effective frequency does reduce again, however the short pauses between the switch-on pulses continue to ensure a lighting current experienced as homogenous. Only in extremely low lighting currents can an undesired flickering of the lighting means occur. This operating state is not required in numerous applications and in these cases requires no technical optimization. However, even in those applications in which very low lighting currents occur, the method presented here provides technical solutions which are the objective of advantageous further developments of the invention.

According to an advantageous further development of the method it is suggested that a lighting current is equivalent to a fraction of the maximum lighting current within a period interval and generates a non-flickering illumination of the semiconductor lighting means of the lighting device, permanently fed as a constant current I_{MIN}_{_{—}}_{KONST} into the lighting device. The semiconductor lighting means are here advantageously supplied permanently with a low controlled threshold current, generating a minimum lighting current and causing semiconductor lighting means to be operated without flickering. In order to increase the lighting current advantageously a respective number of discrete current pulses with a nominal current I_{NENN} is switched to the period intervals. In a full control the nominal current I_{NENN} then flows permanently again.

In another preferred embodiment it is possible for the pulse amplitudes I_{P} at average lighting currents, representing 5-50% of the maximum lighting current, to be adjusted smaller than the nominal current I_{NENN} and that upon reaching a predetermined threshold of the average lighting current the pulse amplitudes I_{P} are adjusted to a higher current, particularly the nominal current I_{NENN} of the semiconductor lighting means. For example, the pulse amplitudes I_{P} for low lighting currents, representing ≦50% of the maximum lighting current, are reduced by a certain factor (for example to 50% of the nominal current I_{NENN}). In order to control this low lighting current the pulse number at reduced pulse amplitudes I_{P} is modulated between 0% and 100%, with a higher pulse frequency ensuring in a particularly beneficial manner from the start a flicker-free operation of the semiconductor lighting means of the lighting device. In order to achieve a higher lighting current then, after reaching a certain threshold of the average lighting current, for example, it is switched back to the nominal current operation and the number of current pulses per period interval is adjusted to the average lighting current.

In a particularly advantageous embodiment it is suggested that the pulse amplitudes I_{P} at average lighting currents, which represent 5.10% of the maximum lighting current, are adjusted to 10% of the nominal current I_{NENN}. In order to control the average lighting current the pulse number is modulated from 0% to 100%, with the pulse amplitude I_{P} being reduced to 10% of the nominal current I_{NENN}. Here, (at a modulation level of 100%) maximally an average lighting current of 10% of the maximum lighting current can be generated. Upon reaching this threshold the pulse amplitude is then increased either immediately to the nominal current I_{NENN} and the pulse number respectively reduced. Alternatively, at least at an additional switching stage the pulse amplitude can once more be adjusted to a value lower than the nominal value I_{NENN}, but greater than 10% of the maximum lighting current. The pulse number is appropriately adjusted and then increased at an increase in lighting current until once more a modulation level of 100% is reached. Then, once more a switching occurs to a higher pulse amplitude I_{P}, which is smaller than the nominal current I_{NENN} or alternatively immediately is adjusted to the nominal value I_{NENN}. The pulse number is once more adjusted appropriately.

In the following, the invention is explained in greater detail based on the attached drawings. Here it shows:

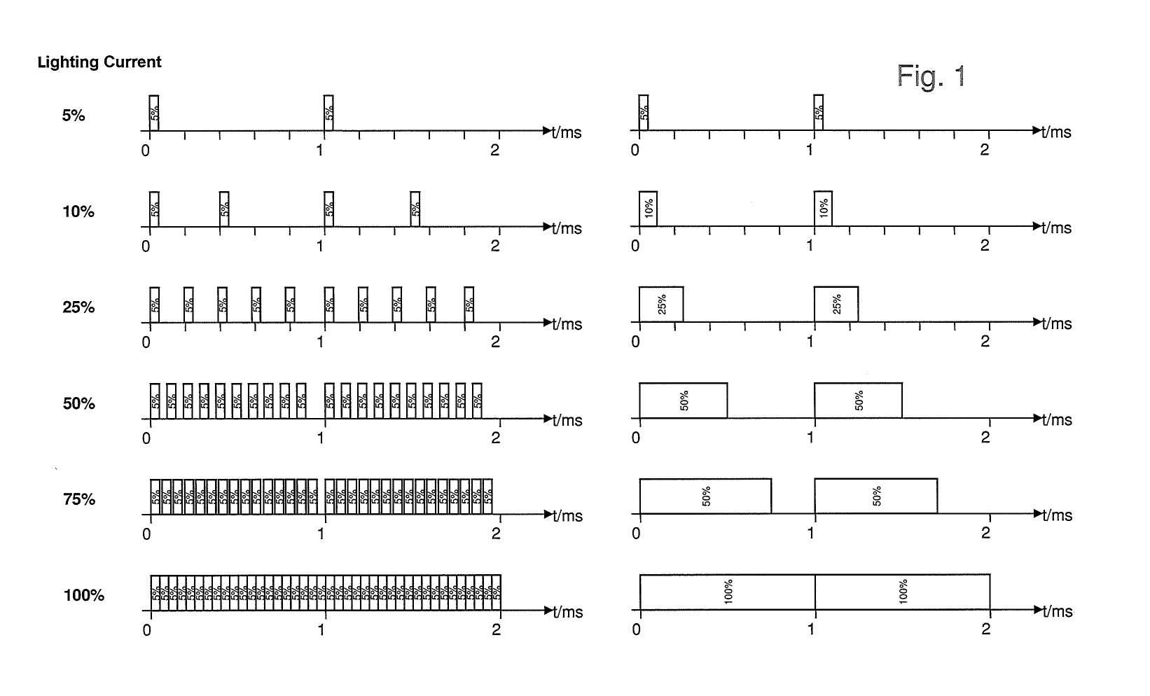

FIG. 1 a comparison between a method according to the invention to control a lighting current of a lighting device with a plurality of semiconductor lighting means installed for signaling and marking traffic areas of airports, such as starting and landing runways or the tarmac, and a conventional pulse width modulation method known from prior art;

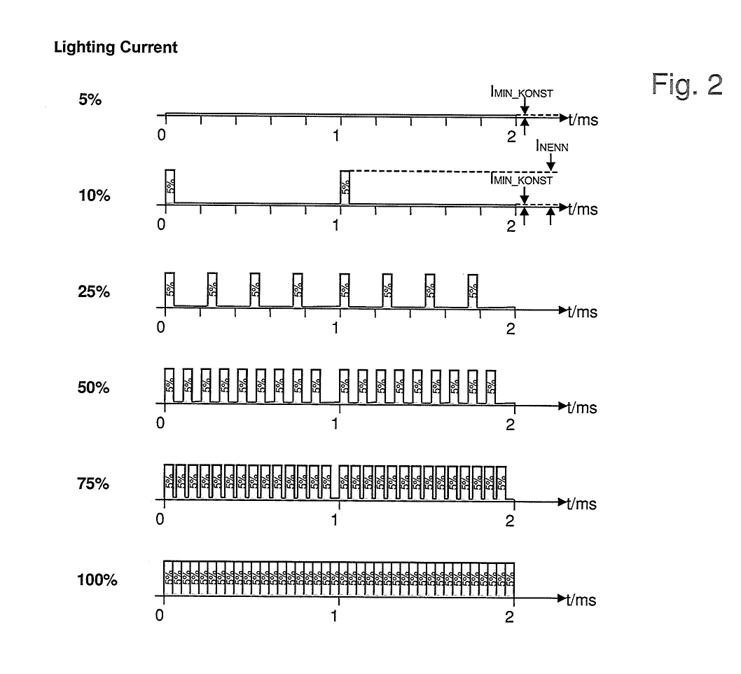

FIG. 2 a first variant of the method with an interfered direct current;

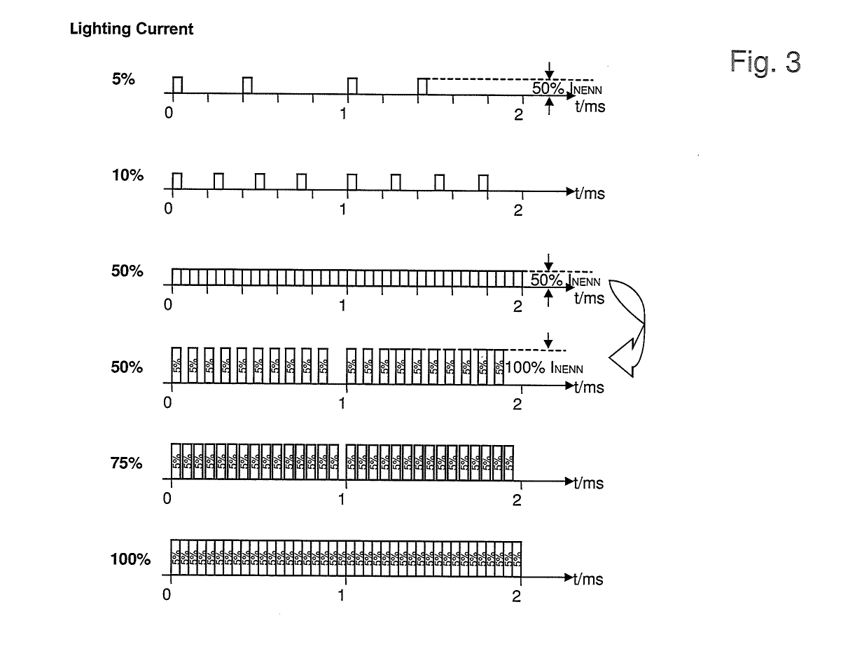

FIG. 3 a second variant of the method with an increase in frequency and simultaneously a reduction of the pulse amplitude.

With reference to FIG. 1, in the following the underlying principle of the method for controlling a lighting current of a lighting device with a plurality of semiconductor lighting means shall be explained in greater detail, which is installed to signal and mark traffic areas of airports, such as starting and landing runways, or the tarmac. Such lighting devices can particularly be provided for sub-surface operation. The semiconductor lighting means may particularly represent light diodes.

In the left part of FIG. 1 the conditions are shown during the execution of the novel addressing method for different average lighting currents between 5% and 100% of the maximum lighting current. At the right side in FIG. 1, for reference purposes, the conditions are shown for a pulse width modulation method of prior art.

In the following, a period interval shall be used as the starting point, which shows a fixed, predetermined length of 1 ms. In FIG. 1, here a total of two subsequent period intervals are shown with a constant period length of 1 ms each. If the semiconductor lighting means are permanently operated during the period interval with their nominal current I_{NENN}, the lighting current amounts to 100% (=maximum lighting current). Only for reasons of simplification of the graphic illustration, in the following it shall be assumed that the semiconductor lighting means of the lighting device are operated with rectangular shaped current pulses with a nominal current I_{NENN} and a fixed pulse duration so that every current pulse reaches a strength of 5% of the maximum lighting current. However, actually the resolution of the control device provided for operating the lighting device is much higher. For example, the individual rectangular power pulses may show a strength of 1/1000 of the maximum lighting current within the period interval.

a) 5% Lighting Current

If the lighting device shall be operated only with an average lighting current of 5% of the maximum lighting current in each of the two period intervals a rectangular power pulse is generated with 5% of the maximum lighting current. During the pulse duration of the current pulse here a nominal current I_{NENN} flows. The same applies for the pulse width modulation method, in which also for each of the two period intervals a current pulse is selected with the nominal current I_{NENN} for its period length such that an arithmetic average of the current is generated equivalent to 5% of the maximum lighting current within the period interval.

b) 10% Lighting Current

If the average lighting current shall now be increased to 10% of the maximum lighting current and thus doubled, in the method according to the invention in each of the two period intervals respectively two discrete power pulses are generated with a nominal current I_{NENN}, each providing 5% of the maximum lighting current within the period interval. Compared thereto, in the pulse width modulation method in each of the two period intervals a current pulse is generated with a nominal current I_{NENN}, yielding 10% of the maximum lighting current. For this purpose, the pulse width (and thus the length of the nominal power pulse) is doubled compared to feeding an average lighting current of 5% of the maximum lighting current.

It is discernible, here, that in the novel method the pulse pause between the first rectangular nominal power pulse and the second rectangular nominal current pulse within the first period interval is slightly shorter than the pulse pause between the second nominal current pulse within the first period interval and the first nominal current pulse within the second period interval. In other words, it is not necessary for the pulse pauses to be consistent between two subsequent power pulses. For example, the pulse pause between the first and the second current pulse within the first period interval is shorter than the pulse pause between the first and the second current pulse within the second period interval. In other words, in the novel control method it is only necessary to increase the number of pulses per period interval in order to double the effective lighting current. It is irrelevant at which point within the period interval the nominal current pulse is generated.

c) 25% Lighting Current

If the lighting device shall be operated with an average lighting current of 25% of the maximum lighting current, in the method according to the invention five nominal current pulses are generated in each period interval with a fixed pulse duration so that the power pulses each yield 5% of the maximum lighting current. Here it is not necessary that the pulse pauses between two subsequent current pulses are each constant. It is only decisive that in each of the two period intervals five discrete current pulses are each generated. Compared thereto, in each of the two period intervals of pulse width modulation an individual current pulse is generated with the strength of the nominal current I_{NENN} and with a pulse length such that the pulse yields 25% of the maximum lighting current within the period interval.

d) 50% Lighting Current

If the lighting device shall be operated with 50% of the maximum lighting current, in one method according to the invention 10 rectangular nominal power pulses are generated in each period interval with a pulse length respectively yielding 5% of the maximum lighting current. Here, it is not necessary that the pulse pauses between two subsequent current pulses each be constant. In each of the two period intervals of pulse width modulation the pulse duration is increased such that a current pulse is generated with 50% of the maximum lighting current.

e) 75% Lighting Current

If one of the lighting devices shall be operated with an average lighting current of 75% of the maximum lighting current in the method according to the invention 15 nominal current pulses are generated in each period interval, respectively yielding 5% of the maximum lighting current. Again, it is not required that the pulse currents each be constant between two subsequent current pulses. In pulse width modulation, the pulse length is increased in each of the two period intervals such that a current pulse is generated with 75% of the maximum lighting current.

f) 100% Lighting Current

In a lighting current amounting to 100% of the maximum lighting current the nominal current I_{NENN} flows in both methods permanently through the semiconductor lighting means of the lighting device. The lighting device is also permanently switched on and the nominal current I_{NENN} flows permanently.

In a comparison of pulse width modulation with the modulation method presented here the conditions “off” (0% lighting current), “lowest dimming level” (5% average lighting current), and “maximum lighting current” (100% lighting current) are identical. However, strictly speaking, they are not allocated to either of the methods. Because the conditions “off” and “on” are static conditions and the lowest dimming level is to a certain extent the basic setting of one or more pulsed operated semiconductor lighting means, with one or the other modulation method being based thereon.

With reference to FIG. 2, in the following a first variant of the above-described method to control a lighting current of a lighting device shall be explained in greater detail using a plurality of semiconductor lighting means. Once more, for reasons of simplification of the graphic illustration it is assumed that the semiconductor lighting means of the lighting device are supplied by a control device with individual rectangular current pulses with a nominal value I_{NENN} and a fixed pulse duration so that each of the pulses shows a strength of 5% of the maximum lighting current within the period interval. Actually, the resolution is much higher, though. For example, the individual power pulses may show a strength of only 1/1000 of the maximum lighting current.

This variant relates to the option for a flicker-free dimming of the semiconductor lighting means of the lighting device. Assuming that in a lighting current of 5% of the maximum lighting current a permanent (flicker-free) illumination of the semiconductor lighting means of the lighting device can be achieved, this lighting current is permanently supplied to the lighting device as a constant current 1_{MIN}_{_{—}}_{KONST}.

If the lighting current shall now be increased from 5% to 10% of the maximum lighting current here in each period interval, once more showing a length of 1 ms, in addition to the constant current I_{MIN}_{_{—}}_{KONST} another respectively rectangular nominal current pulse is generated with 5% of the maximum lighting current each. In order to generate a lighting current of 25% of the nominal current I_{NENN} in each of the period intervals, in addition to the constant current I_{MIN}_{_{—}}_{KONST} four, in 50% of the nominal current I_{NENN} nine, and in 75% of the nominal current I_{NENN} fourteen additional current pulses are generated with 5% of the respective maximum lighting current. Here, once more it is not required that the pulse pauses between subsequent current pulses are each constant. It is therefore not necessary to increase the number of pulses per period interval in order to increase the lighting current. It is irrelevant at which position within the period interval the pulses are generated.

With reference to FIG. 3 in the following a second variant of the above-described method to control a lighting current of a lighting device with a plurality of semiconductor lighting means shall be explained in greater detail.

Once more, for reasons of simplifying the graphic illustration it is assumed in the following that the semiconductor lighting means of the lighting device can be operated with discrete rectangular current pulses with a nominal current I_{NENN} and a fixed pulse duration so that each current pulse can reach a strength of 5% of the maximum lighting current. Actually, the resolution of the control device is much higher, though. For example, the individual rectangular current pulses may show a strength of 1/1000 of the maximum lighting current within the period interval. Additionally it is possible in this variant to generate current pulses showing a pulse amplitude which is smaller than the nominal current I_{NENN}.

This variant therefore discusses the option of a flicker-free dimming of the semiconductor lighting means of the lighting device. Unlike the above-described variant, here no additional lighting current is fed into the lighting device in the form of a constant current I_{MIN}_{_{—}}_{KONST}. Rather, at an average lighting current strength from 5% to 50% discrete current pulses are generated, with their pulse amplitudes being smaller, preferably considerably smaller than the nominal current I_{NENN}. Here, pulses are generated showing a pulse amplitude equivalent to 50% of the nominal current I_{NENN} of the semiconductor lighting means.

In order to generate an average lighting current equivalent to 5% of the maximum lighting current within the period interval here in each period interval two current pulses are generated with a predetermined pulse length and half the nominal current I_{NENN}. Similar (conditions) apply for example for lighting currents up to an average lighting current of 50%, in which the number of current pulses are each doubled in reference to the situation respectively shown in FIG. 1. At an average lighting current of 50% a permanent current flows with a strength of 50% of the nominal current I_{NENN}. Then, switching occurs from a modulation level of 100% and a pulse amplitude equivalent to half the nominal current I_{NENN}, to a pulse amplitude per pulse generated of 100% of the nominal current I_{NENN} with a modulation level of 50%. This situation is also shown in FIG. 3. If the lighting current shall be increased further, once more the situation develops already shown in FIG. 1. If the lighting device shall be operated with an average lighting current of 75% of the maximum lighting current, in each period interval once more 15 nominal current pulses are generated, each yielding 5% of the maximum lighting power. Here, it is not required either that the pulse pauses between two subsequent current pulses are each constant. At a lighting current equivalent to 100% of the maximum lighting current the nominal current I_{NENN} flows permanently through the semiconductor lighting means of the lighting device. The lighting device is therefore permanently switched on and the nominal current I_{NENN} flows permanently.

Here it shall be mentioned that the initial reduction of the pulse amplitudes to 50% of the nominal current I_{NENN} once more is only an example. It is more effective to reduce the current flowing in each current pulse to 10% of the nominal current I_{NENN}. In order to control the lighting current the number of pulses is modulated from 0% to 100%, with the pulse amplitude I_{P} being reduced to 10% of the nominal current I_{NENN}. Here, maximally an average lighting current of 10% of the maximum lighting current can be generated (at a modulation level of 100%). Upon reaching this threshold the pulse amplitude is then either immediately increased to the nominal current I_{NENN} and the number of pulses accordingly reduced. Alternatively in at least one additional switching step the pulse amplitude can once more be adjusted to a value smaller than the nominal current I_{NENN}, but greater than 10% of the maximum lighting current. The number of pulses is also adjusted accordingly and then, upon increasing the lighting current, is further increased until once more the modulation level of 100% is reached. Then a renewed switching occurs to a higher pulse amplitude I_{P}, which may be smaller than the nominal current I_{NENN} or is immediately adjusted to the nominal current I_{NENN}. The number of pulses is once more adjusted accordingly.

1. A method to control a lighting current of a lighting device with a plurality of semiconductor lighting means, provided to signal and mark traffic areas in airports, comprising the steps of:
predetermining period intervals with a fixed period length, selecting an average lighting current to operate the semiconductor lighting means within the period intervals,
generating in each of the period intervals a plurality of current pulses with a pulse amplitude I_{P} and a fixed pulse duration T, and
selecting the number of current pulses per period interval such that within the period interval the respectively selected average lighting current is reached, with the pulse pauses between subsequent current pulses being adjusted variably.

2. A method according to claim 1, further comprising the step of triggering a pulse generator suitable for generating current pulses is within a fixed period interval by a counter so frequently that the average lighting current is achieved, and wherein the counter is reset at the end of the period interval and started anew for the subsequent period interval.

3. A method according to claim 1, further comprising the step of adjusting the pulse amplitudes I_{P} of at least some current pulses to the nominal current I_{NENN} of the semiconductor lighting means.

4. A method according to claim 1, further comprising the step of adjusting the pulse amplitudes I_{P} of at least some current pulses are adjusted such that they are smaller than the nominal current I_{NENN} of the semiconductor lighting means.

5. A method according to claim 1, further comprising the step of feeding a lighting current, equivalent to a fraction of the maximum lighting current within a period interval and generating a non-flickering illumination of the semiconductor lighting means in the lighting device, as a constant current I_{MIN}_{_{—}}_{KONST} to the lighting device.

6. A method according to claim 5, wherein the constant current I_{MIN}_{_{—}}_{KONST} is fed to the lighting device with a strength of maximally 5% of the maximum lighting current.

7. A method according to claim 5, further comprising the step of adding a respective number of discrete current pulses in the period intervals with a nominal current I_{NENN} to increase the lighting current.

8. A method according to claim 1, wherein the pulse amplitudes I_{P} at average lighting currents, representing ≦50% of the maximum lighting current, are adjusted lower than the nominal current I_{NENN} and that upon reaching a threshold of the average lighting current the pulse amplitudes I_{P} are adjusted to a higher current, particularly to a nominal current I_{NENN} of the semiconductor lighting means.

9. A method according to claim 8, wherein the pulse amplitudes I_{P}, at average lighting currents, representing ≦10% of the maximum lighting current, are adjusted to 10% of the nominal current I_{NENN}.
